(19) United States
(12) Patent Application Publication
(10) Pub. No.: US 2022/0375306 A1
(43) Pub. Date: Nov. 24, 2022

(54) Gaming Machines and Gaming Machine Control Methods with Multiple Bonus Feature Paths

(71) Applicant: Everi Games Inc., Austin, TX (US)

(72) Inventors: Scott Slomiany, Chicago, IL (US); Justine Klein, Chicago, IL (US); Juan Mariscal, Chicago, IL (US)

(73) Assignee: Everi Games Inc., Austin, TX (US)

(21) Appl. No.: 17/729,116

(22) Filed: Apr. 26, 2022

Related U.S. Application Data
(60) Provisional application No. 63/190,874, filed on May 20, 2021.

(51) Int. Cl. G07F 17/32

(52) U.S. Cl. CPC G07F 17/3267; G07F 17/3211

(57) ABSTRACT

A method includes conducting a base portion of a game in which the base portion result may include a first trigger condition or a second trigger condition. Where the base portion result includes the first trigger condition, the method includes conducting a first bonus feature which may include activations of reels defining a first array of game symbol locations. Where the base portion result includes the second trigger condition, the method includes causing the display system to display a selection from among a number of different additional bonus feature options at least one of which comprises a reel-type bonus feature which includes activations of reels defining a second array of game symbol locations larger than the first array.

### CROSS-REFERENCE TO RELATED APPLICATION

Applicant claims the benefit, under 35 U.S.C. § 119(e), of U.S. Provisional Patent Application No. 63/190,874 filed May 20, 2021, and entitled “Gaming Machines and Gaming Machine Control Methods with Multiple Bonus Feature Paths.” The entire content of this provisional application is incorporated herein by this reference.

### COPYRIGHT NOTICE

A portion of the disclosure of this patent document contains material subject to copyright protection. The copyright owner has no objection to the facsimile reproduction of the patent document or the patent disclosure as it appears in the U.S. Patent and Trademark Office patent files or records, but otherwise reserves all rights.

### TECHNICAL FIELD OF THE INVENTION

The invention relates to gaming machines for conducting reel-type games and to methods for controlling gaming machines to provide multiple free spin-type bonus features. The invention also encompasses program products for controlling gaming machines.

### BACKGROUND OF THE INVENTION

Mechanical and video reel-type gaming machines display results for a given play in the game using an array of game symbol locations. In the course of a play at a reel-type gaming machine, the various game symbols appearing at the different game symbol locations (or at least some of the different game symbol locations) are randomized or selected according a random result. The randomization or apparent randomization is performed by spinning a reel that carries on its periphery the various game symbols for the game, or, in the case of video reel-type gaming machines, by conducting a spin simulation for one or more simulated reels shown on a video display. The term “reel” as used in this disclosure and the accompanying claims is intended to encompass any physical or simulated rotatable element that carries the game symbols for a given game. A reel-type gaming machine may include physical or simulated multiple-symbol reels that each provide multiple game symbol locations in the array, or may include physical or simulated single-symbol reels that each show only a single game symbol location of the array.

Winning results may be defined for a given combination of game symbols appearing in a predefined winning game symbol location pattern commonly referred to as a “payline” defined through the array of game symbol locations. Winning results may also be defined in terms of the number of a given game symbol or different game symbols appearing in the array after randomization, commonly referred to as a “scatter pay.” The combinations of game symbols that represent a winning result along a payline or as a scatter pay are defined in a pay table that relates each such combination of game symbols to a respective prize, or multiple prizes. Each such prize may correspond to a bet level in effect for the play in the game. Any prizes as defined by the pay table are awarded in some fashion during a given play or at the completion of the play such as by incrementing a credit meter at the gaming machine.

Reel-type gaming machines may offer bonus games in addition to a primary or base game conducted at a gaming machine. Such bonus games are seen as a way to vary the player's gaming experience at a given gaming machine and may involve spins of the same or different physical or simulated reels defining the original game symbol location array. One common and historically popular type of bonus game includes a number of spins of a set of physical or simulated reels in rapid succession without requiring a separate wager for each spin. This type of bonus game or feature is commonly referred to as a “free spin” bonus. Such bonus games provide the excitement of a number of spins in rapid succession while using the same underlying game mechanic to display wins, namely, a spin of reels to display results via the game symbols appearing on the reels. By using the same game mechanic, the player is not obliged to learn or understand a different arrangement for displaying results.

### SUMMARY OF THE INVENTION

An aspect of the present invention includes methods for controlling a gaming machine to provide multiple different bonus features of a common type, particularly different free-spin bonuses. Additional aspects of the present invention encompass apparatus and program products providing such multiple bonus features of a common type.

Methods according to a first aspect of the present invention are conducted at a gaming machine under control of a processing system and include conducting a base portion of a game in which the base portion result may include a first trigger condition or a second trigger condition. Where the base portion result includes the first trigger condition, the methods include conducting a first bonus feature. However, where the base portion result includes the second trigger condition, methods according to this aspect of the invention include causing the display system to display a selection from among a number of different additional bonus feature options. At least one of these different additional bonus feature options includes a second bonus feature, and where the selection identifies the second bonus feature, methods according to this aspect of the invention include conducting the second bonus feature.

In conducting the first bonus feature, the display system displays a number of reels to produce a first array of game symbol locations having at least two rows and at least two columns. A number of activations of the reels that produce the first array are conducted with each activation populating at least some of the game symbol locations of the first array with a respective game symbol from a set of game symbols for the first bonus feature to produce a respective first bonus feature activation result. For each first bonus feature activation result, methods according to this aspect of the invention include awarding any prize defined for any pattern of game symbols present in the first array of game symbol locations for that first bonus feature activation result. Upon completion of the first bonus feature, the display system may return to a base portion graphic state for the conduct of the base portion of another instance of the game.

In conducting the second bonus feature, the display system similarly displays a number of activations of a number of reels, each activation producing a respective second bonus feature activation result. However, the reels for the second bonus feature produce a second array of game symbol locations larger than the first array of game symbol locations. The second array is larger than the first array in the sense that the second array includes at least one more column of game symbol locations or at least one more row of game symbol locations than the first array. For example, implementations of this first aspect and the other aspects of the invention may include twice as many rows of game symbol locations as the first array of game symbol locations, essentially doubling the size of the array. For each second bonus feature activation result with this larger second array of game symbol locations, prizes are awarded similarly to the first bonus feature. Also similarly to the first bonus feature, upon completion of the second bonus feature, the display system may return to the base portion graphic state for the conduct of the base portion of another instance of the game.

Methods according to this first aspect of the invention facilitate two different free spin-type bonus features, each such bonus feature reached through a different path. Providing the two different bonus features of a common type allows for a more varied playing experience for the players without necessarily requiring the players to learn a different game mechanic. Methods according to the first aspect of the invention take advantage of the popular free spin-type game mechanic while still providing a more varied gaming experience.

A second aspect of the invention encompasses a gaming machine configured to perform methods according to the first aspect of the invention. Gaming machines according to this second aspect of the invention include a player input system, a display system, a processing system including at least one processor, and at least one memory device. The at least one memory device stores instructions executable by the processing system to perform methods according to the first aspect of the invention.

A third aspect of the invention encompasses a program product comprising one or more non-transitory computer readable data storage devices storing program code for a gaming machine such as one according to the second aspect of the invention. The program code includes base game program code, first bonus feature program code, bonus feature selection program code, second bonus feature program code, and prize assignment program code, all executable by a processing system of the gaming machine. The base game program code is executable by the gaming machine processing system to cause the display system of the gaming machine to display a base portion of a game as described above. The first bonus feature program code and second bonus feature program code are each executable respectively by the gaming machine processing system to control the display system in the conduct of the respective bonus feature as described above. The bonus feature selection program code is executable by the processing system to control the display system in the above-described selection between different additional bonus feature options including the second bonus feature. The prize assignment program code is executable by the processing system to award prizes defined for the base portion result and for activations in the first bonus feature and second bonus feature, as well as for activations of other additional bonus features which may be selected in the additional bonus feature selection process.

In implementations according to any of the aspects described above, displaying the base portion of the game may include causing the display system to display a base portion activation of the reels that produce the first array of game symbol locations. That is, the base portion of the game employs the same arrangement of reels employed as well for the first bonus feature. This base portion activation populates at least some of the game symbol locations of the first array with a respective game symbol from a set of game symbols for the base portion of the game. The set of game symbols for the base portion of the game may or may not be the same set of game symbols as used for the first bonus feature. In these implementations employing the same reels for both the base portion of the game and the first bonus feature, the first trigger condition may comprise a state of the first array for a base portion result in which a column of game symbol locations in the first array comprises a first bonus stacked symbol group. In this first bonus stacked symbol group, each game symbol location in that column of game symbol locations displays a respective first bonus symbol. Such a bonus symbol may comprise a “wild” symbol for example. As used in this disclosure and the accompanying claims a “wild” symbol comprises a symbol that is interpreted along a given payline as any symbol necessary to produce a winning symbol combination along that payline.

Where a first bonus stacked symbol group is employed as the first trigger condition, the display system may be controlled for the first bonus feature so that the pattern defined by that symbol group stays intact for each activation, but moves in a column movement direction for at least some activations. The graphic presentation of the first bonus stacked symbol group may change in the course of the first bonus feature, but the pattern, that is, the column of symbol locations in this example, remains intact preferably throughout the conduct of the first bonus feature. Thus the column defined by the stacked symbols (or other graphic which may replace the stacked symbols) appears to march across the reel-type display in the column movement direction over the course of the first bonus feature. The first bonus feature may end on the activation in which the column defined by the stacked symbols resides in the final column of the array in the column movement direction. Implementations of the invention may also allow the first trigger condition, and particularly the first bonus stacked symbol group to land again in the array and retrigger the first bonus feature for additional activations. In these cases, the first bonus feature may end on the activation in which the last first bonus stacked symbol group is in the final column of the array in the column movement direction.

In implementations according to any of the aspects of the invention, the selection between the different additional bonus feature options may comprise the rotation of a selection element such as a physical or video-simulated wheel or reel. The different additional bonus feature options may be defined as different segments on the selection element and the selection of a given bonus feature option may be shown as the segment for that option landing in a certain position at the time the selection element comes to rest.

Implementations according to any of the aspects of the invention may include displaying the second array of game symbol locations as including a second bonus stacked symbol group similar to the first bonus stacked symbol group described above for the first bonus feature. Such a second bonus stacked symbol group may include a column of the second array in which each game symbol location in the column includes a second bonus symbol such as a wild symbol for example. The display system may be controlled for the second bonus feature so that the pattern defined by second bonus stacked symbol group stays intact for each activation, but moves in the column movement direction for at least some of the activations of the reels defining the second array. Thus the column defined by the stacked symbols for the second bonus appears to march across the reel-type display in the column movement direction over the course of the second bonus feature similarly to the stacked symbols in the first bonus feature. As with the first bonus feature, the second bonus feature may end on the activation in which the column defined by the stacked symbols resides in the final column of the array in the column movement direction. Implementations of the second bonus feature may include retriggering similar to the retriggering described above for the first bonus feature.

These and other advantages and characteristics of the invention will be apparent from the following description of representative embodiments, considered along with the accompanying drawings.

### BRIEF DESCRIPTION OF THE DRAWINGS

FIG. 1 is an isometric view of a gaming machine that may be used for implementations of the present invention.

FIG. 2 is a block diagram showing the various components that may be included in the gaming machine shown in FIG. 1.

FIG. 3 is a block diagram of a gaming system including gaming machines such as that shown in FIG. 1.

FIG. 4 is a process flow diagram of an example process according to an aspect of the present invention.

FIG. 5 is a representation of a gaming machine display system controlled in accordance with aspects of the present invention to show the occurrence of a first trigger condition.

FIG. 6 is a representation of the gaming machine display system of FIG. 5 at a point in time in the conduct of a first bonus feature in response to the first trigger condition.

FIG. 7 is a representation of the gaming machine display system of FIG. 5 at a point in time in the conduct of the first bonus feature after that depicted in FIG. 6.

FIG. 8 is a representation of the gaming machine display system of FIG. 5 at a point in time in the conduct of the first bonus feature after that depicted in FIG. 7.

FIG. 9 is a representation of the gaming machine display system of FIG. 5 at a point in time in the conduct of the first bonus feature after that depicted in FIG. 8.

FIG. 10 is a representation of the gaming machine display system of FIG. 5 controlled in accordance with aspects of the invention to show an additional bonus feature selection initiating display produced in response to a second trigger condition in a base portion result.

FIG. 11 is a representation of the gaming machine display system of FIG. 5 controlled in accordance with aspects of the invention to show a selection display produced in response to a spin input in the state of the gaming machine display system shown in FIG. 10.

FIG. 12 is a representation of the gaming machine display system of FIG. 5 controlled in accordance with aspects of the invention to show a display produced as a result of the spin indicated in FIG. 11.

FIG. 13 is a representation of the gaming machine display system of FIG. 5 controlled in accordance with aspects of the invention to show a display produced for a second bonus feature in accordance with aspects of the invention in response to the result indicated in FIG. 12.

FIG. 14 is a representation of the gaming machine display system of FIG. 5 at a point in time in the conduct of the second bonus feature after that depicted in FIG. 13.

FIG. 15 is a representation of the gaming machine display system of FIG. 5 at a point in time in the conduct of the second bonus feature after that depicted in FIG. 14.

FIG. 16 is a block diagram showing software and data structures that may be employed in an implementation of the present invention.

### DESCRIPTION OF REPRESENTATIVE EMBODIMENTS

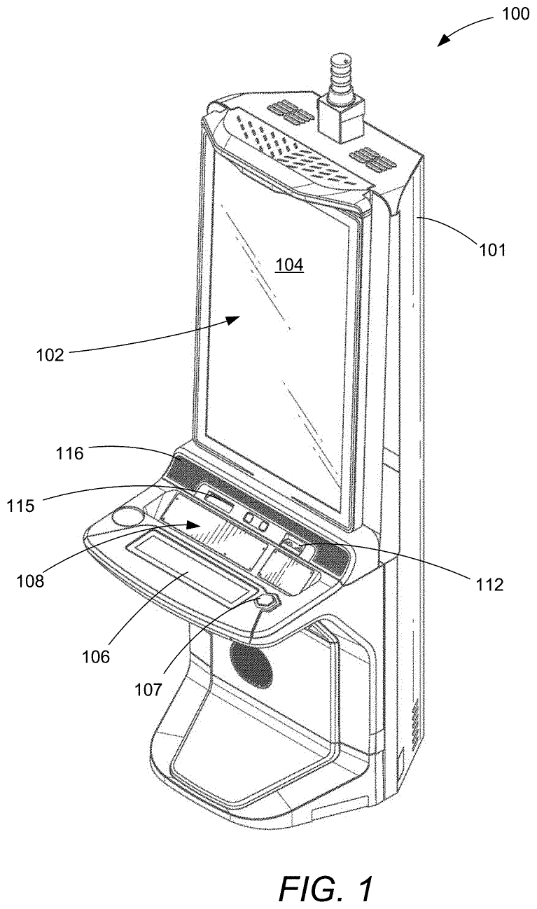

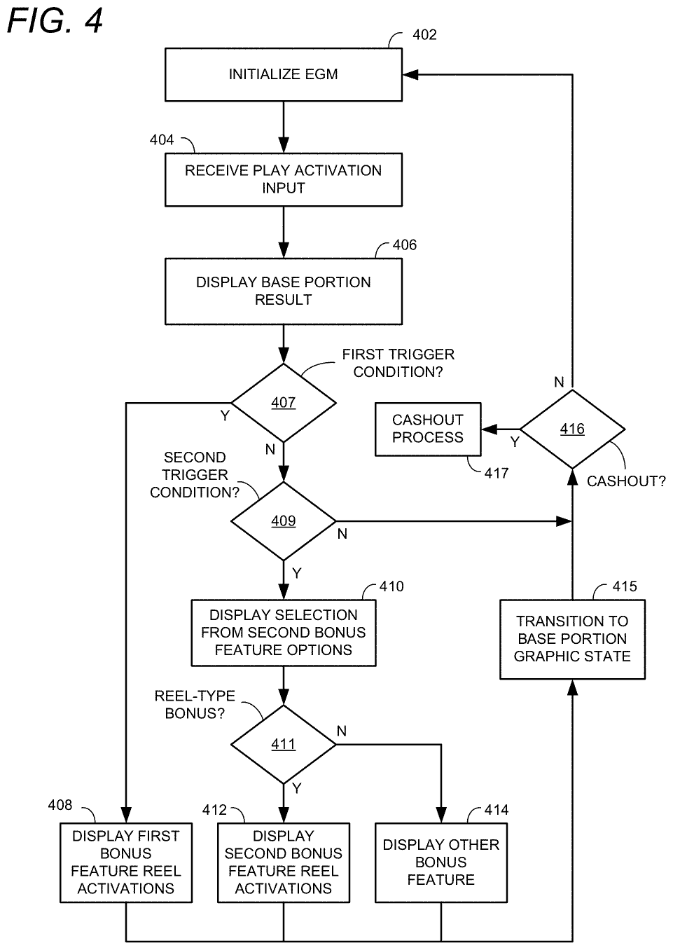

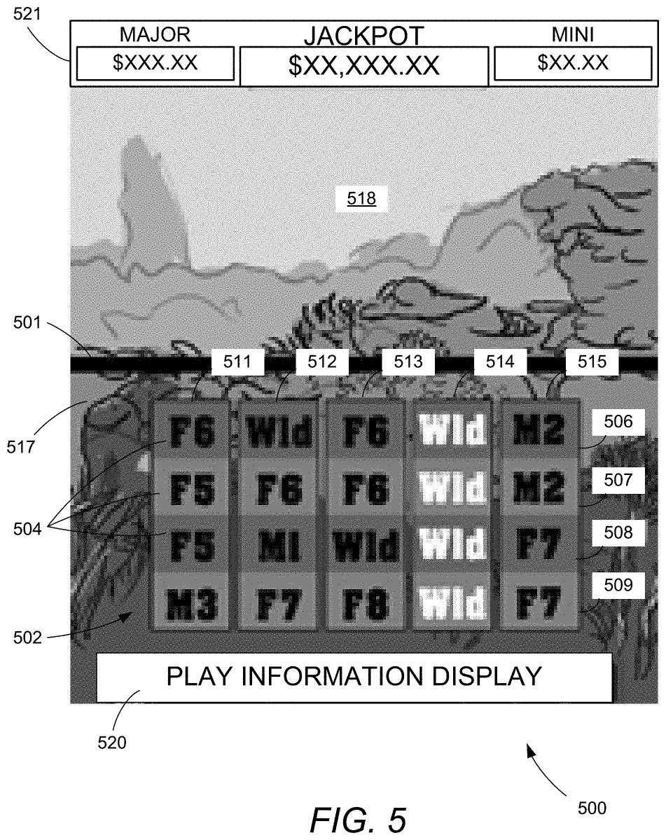

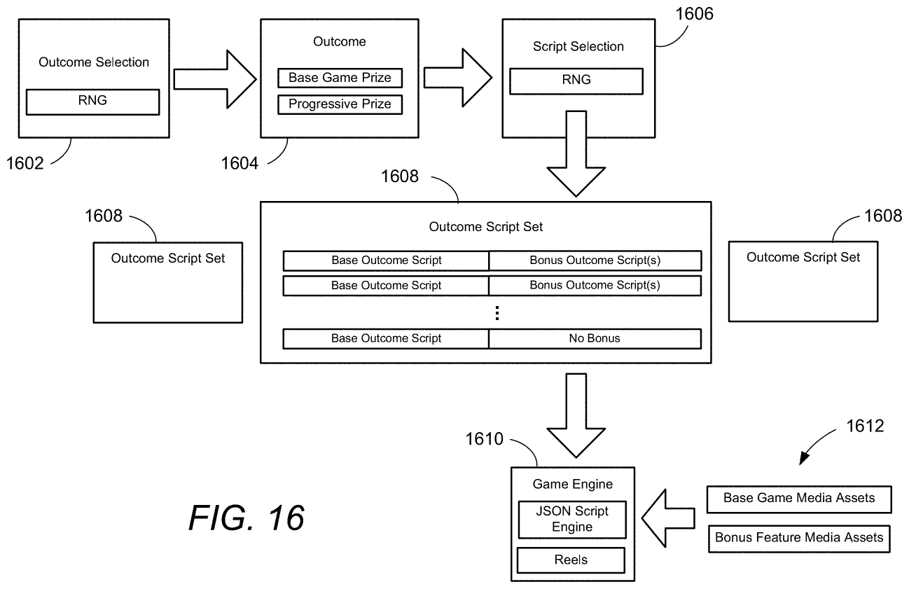

FIGS. 1-3 will be used to describe gaming machines and gaming networks in which aspects of the present invention may be implemented. FIG. 4 will be used to describe example methods of controlling a gaming machine according to various implementations of the present invention. FIGS. 5-15 will be referenced below to describe example implementations of first and second bonus features in accordance with the present invention. FIG. 16 will be referenced below to describe certain software and data structures that may be employed in implementations of the invention.

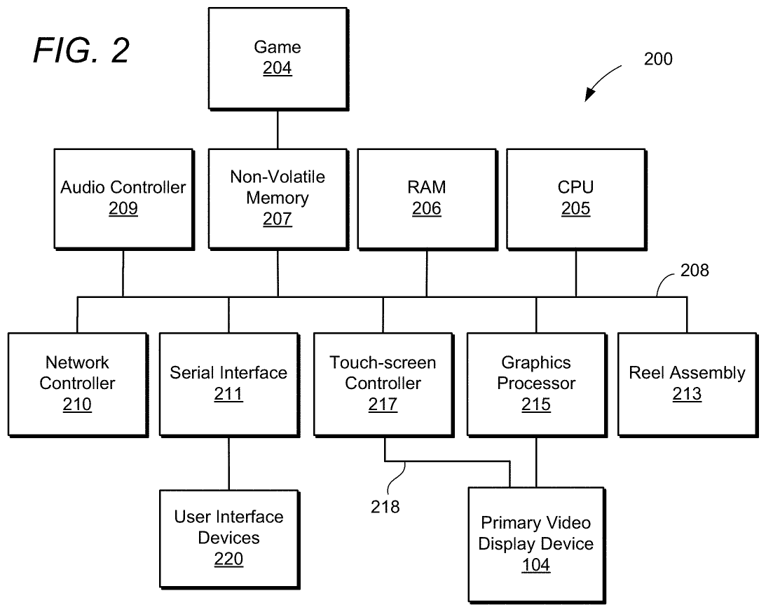

Referring to FIG. 1, gaming machine 100 includes a cabinet 101 having a front side generally shown at reference numeral 102. A primary video display device 104 is mounted in a central portion of the front side 102 and a touch-screen button panel 106 is positioned below the primary video display device. Gaming machine 100 may include additional smaller auxiliary display devices (not shown) and/or other devices in the area shown generally at 108. It should also be noted that each display device referenced herein may include any suitable display device including a cathode ray tube, liquid crystal display, plasma display, LED display, or any other type of display device currently known or that may be developed in the future. One or more of these video display devices, and especially primary video display device 104, may be used to display graphics associated with a base portion of a game and multiple bonus features in accordance with aspects of the present invention. As will be described further below in connection with FIG. 2 and elsewhere, it is also possible for gaming machines within the scope of the present invention to include mechanical elements such as mechanical reels. Generally, the display device or display devices of the gaming machine, through which a reel-type game may be presented may be described in this disclosure and the accompanying claims as a “display system” regardless of whether the gaming machine in question includes one or more video display devices showing graphic elements such as reel simulations, or physical reels, or combinations of the two. The term “display” when not used to qualify a term such as “device,” “apparatus,” or “system,” for example, will be used in this disclosure and accompanying claims to refer to an arrangement of one or more graphic elements shown by a display device or to the act of displaying such graphic elements by a display device unless explicitly indicated otherwise.

The gaming machine 100 illustrated for purposes of example in FIG. 1 also includes a mechanical control button 107 mounted adjacent to touch-screen button panel 106. This control button 107 may allow a player to make a play input to start a play in a game conducted through gaming machine 100, while virtual buttons included (but not shown in this view) on button panel 106 or other physical buttons or controls (not shown) may allow a player to select a bet level for a game implemented at the gaming machine, select a type of game or game feature, and make other inputs at the gaming machine preparatory to or during the play of a game at the gaming machine. Touch-screen button panel 106 may also be used in implementations of reel-type games encompassing aspects of the invention to allow the player to control a cursor that may be displayed on another display device. Other forms of gaming machines through which the invention may be implemented may include switches, joysticks, or other mechanical input devices in addition to the virtual buttons and other controls implemented on touch-screen button panel 106. Additionally, primary video display device 104 in gaming machine 100 provides a convenient display device for implementing touch screen controls in addition to or in lieu of controls included on touch-screen button panel 106 or mechanical controls. The player interface devices which receive player inputs in the course of a game played through the gaming machine, such as controls to select a wager amount for a given play, controls to enter a play input to actually start a given play in the game, or controls to allow a player to make other player inputs in a game controlled according to the present invention, may be referred to generally as a “player input system.”

It will be appreciated that gaming machines may also include a number of other player interface devices in addition to devices that are considered player controls for use in entering inputs in the course of a particular game. Gaming machine 100 also includes a currency/voucher acceptor having an input ramp 112, a voucher/receipt printer having a voucher/receipt output 115, and a player card reader (not shown in the view of FIG. 1). Numerous other types of player interface devices may be included in gaming machines that may be used to implement embodiments of the present invention.

Gaming machine 100 may also include a sound system to provide an audio output to enhance the user's playing experience. For example, illustrated gaming machine 100 includes speakers behind grille 116 which may be driven by a suitable audio amplifier (not shown) to provide a desired audio output at the gaming machine.

FIG. 2 shows a logical and hardware block diagram 200 of gaming machine 100 that includes a processor (CPU) 205 along with random access memory (RAM) 206 and nonvolatile memory or storage device 207. All of these devices are connected on a system bus 208 with an audio controller device 209, a network controller 210, and a serial interface 211. A graphics processor 215 is also connected on bus 208 and is connected to drive primary video display device 104 (the display device 104 being mounted on cabinet 101 as shown in FIG. 1). As shown in FIG. 2, gaming machine 100 also includes a touch screen controller 217 connected to system bus 208. Touch screen controller 217 is also connected via signal path 218 to receive signals from a touch screen element associated with primary video display device 104 or touch-screen button panel 106 or both. It will be appreciated that the touch screen element itself typically comprises a thin film that is secured over the display surface of the respective display device such as the display device of touch-screen button panel 106 in FIG. 1. The touch screen element itself is not illustrated or referenced separately in the figures. The present invention is not limited to any particular touch-screen technology.

Those familiar with data processing devices and systems will appreciate that other basic electronic components will be included in gaming machine 100 such as a power supply, cooling systems for the various system components, audio amplifiers, and other devices that are common in gaming machines. These additional devices are omitted from the drawings so as not to obscure the present invention in unnecessary detail.

All of the elements 205, 206, 207, 208, 209, 210, and 211 shown in FIG. 2 are elements commonly associated with a personal computer, although they may be specially designed and configured for use in a wagering game environment. These elements may be mounted on (or connected to) a motherboard and housed in a personal computer housing which itself may be mounted in cabinet 101 shown in FIG. 1. Alternatively, the various electronic components may be mounted on one or more circuit boards housed within cabinet 101 without a separate enclosure such as those found in personal computers. Those familiar with data processing systems and the various data processing elements shown in FIG. 2 will appreciate that many variations on this illustrated structure may be used within the scope of the present invention. For example, since serial communications are commonly employed to communicate with a touch-screen controller such as touch screen controller 217, the touch-screen controller may not be connected on system bus 208, but instead include a serial communications line to serial interface 211, which may be a USB controller for example. It will also be appreciated that some of the devices shown in FIG. 2 as being connected directly on system bus 208 may in fact communicate with the other system components through a suitable expansion bus. Audio controller 209, for example, may be connected to the system via a PCI or PCIe bus or bus configured according to some other expansion bus standard. System bus 208 is shown in FIG. 2 merely to indicate that the various components are connected in some fashion for communication with CPU 205 and is not intended to limit the invention to any particular bus architecture.

Numerous other variations in the gaming machine internal structure and system may be used without departing from the principles of the present invention. For example, a gaming machine in some embodiments of the present invention may rely on one or more data processors located remotely from the gaming machine itself. Embodiments of the present invention may include no processor such as CPU 205 or graphics processor such as 215 at the gaming machine, and may instead rely on one or more remote processors. Thus unless specifically stated otherwise, the designation “gaming machine” is used in this disclosure and the accompanying claims to designate a system of devices which operate together to provide the indicated functions. A “gaming machine” may include a gaming machine such as gaming machine 100 shown in FIGS. 1 and 2, that is itself a system of various components, and may also include one or more components remote from a gaming machine cabinet (that is, cabinet 101 in FIG. 1). Thus the designation “gaming machine” encompasses both a stand-alone gaming machine and a gaming machine (that is, the part housed in a cabinet such as cabinet 101 in FIG. 1) along with one or more remote components for providing various functions (such as identifying prizes for a given play and controlling reel spin simulations, and performing other operations described below in connection with the example process shown in FIG. 4).

It will also be appreciated that graphics processors are also commonly a part of modern computer systems. Although separate graphics processor 215 is shown for controlling primary video display device 104, CPU 205 or a graphics processor packaged with or included with CPU 205 may control all of the display devices directly without any separately packaged graphics processor. The invention is not limited to any particular arrangement of processing devices for controlling the video display devices included with gaming machine 100. Also, a gaming machine implementing the present invention is not limited to any particular number of video display devices or other types of display devices. While the large display device 104 is particularly suited for showing displays in accordance with some implementations in accordance with aspects of the present invention, the display device area may be arranged differently than the portrait orientation shown or divided across multiple discrete display devices within the scope of the present invention.

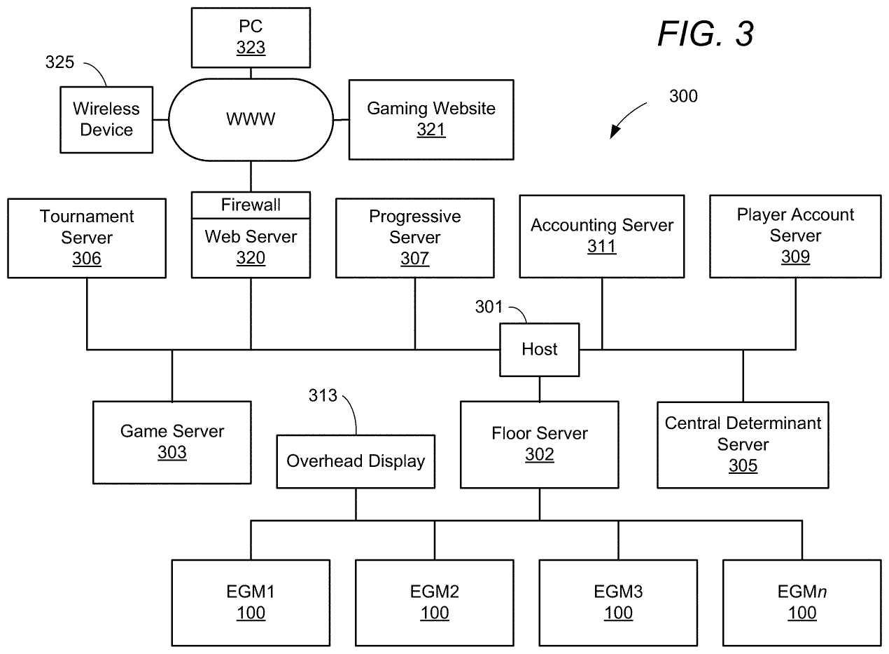

In the illustrated gaming machine 100, CPU 205 executes software, that is, program code, that ultimately controls the entire gaming machine including the receipt of player inputs and the presentation of the graphics or information displayed according to the invention through the display devices 104 and 106 associated with the gaming machine. In particular, CPU 205 may execute the base game program code, first and second bonus feature program code, bonus feature selection program code, and prize assignment program code described in the Summary section above and described further below in connection with the examples processes and displays. CPU 205 also executes software related to communications handled through network controller 210, and software related to various peripheral devices such as those connected to the system through audio controller 209, serial interface 211, and touch screen controller 217. CPU 205 may also execute software to perform accounting functions associated with game play. Random access memory 206 provides memory for use by CPU 205 in executing its various software programs while the nonvolatile memory or storage device 207 may comprise a hard drive or other mass storage device providing storage for game software (program code) prior to loading into random access memory 206 for execution, or for programs not in use or for other data generated or used in the course of gaming machine operation. Network controller 210 provides an interface to other components of a gaming system in which gaming machine 100 may be included. An example network will be described below in connection with FIG. 3.

It should be noted that the invention is not limited to gaming machines employing the personal computer-type arrangement of processing devices and interfaces shown in example gaming machine 100. Other gaming machines through which the invention may be implemented may include one or more special purpose processing devices to perform the various processing steps for implementing the invention. Unlike general purpose processing devices such as CPU 205, which may comprise an Intel® or AMD® processor for example, these special purpose processing devices may not employ operational program code to direct the various processing steps.

The example gaming machine 100 is shown in FIG. 2 as including user interface devices 220 (part of a player input system) connected to serial interface 211. These user interface devices may include various player input devices such as mechanical buttons, virtual buttons shown on touch-screen button panel 106 in FIG. 1, and/or levers, and other devices. It will be appreciated that the interface between CPU 205 and other player input devices such as player card readers, voucher readers or printers, and other devices may be in the form of serial communications. Thus serial interface 211 may be used for those additional devices as well, or the gaming machine may include one or more additional serial interface controllers. However, the interface between peripheral devices in the gaming machine, such as player input devices, is not limited to any particular type or standard for purposes of the present invention.

Reel Assembly 213 is shown in the diagrammatic representation of FIG. 2 to illustrate that a gaming machine that may present reel-type games in accordance with aspects of the present invention may also include mechanical reels. For example, a number of sets of mechanical reels may replace the primary display device 104, or at least part of that display device. Alternatively, mechanical reels may be included in the gaming machine behind a light-transmissive video display panel. Mechanical reels may also include one or more video display devices in place of a static reel symbol strip and thus be capable of conducting single-symbol reel spin simulations for one or more game symbol locations. In any case, the mechanical reels represent a display device for displaying various game symbols in the course of controlling the gaming machine. Although the invention is not limited to any particular mechanical reel arrangement or control system, mechanical reels may be controlled conveniently through serial communications that provide instructions for a respective stepper motor for each reel. Thus some embodiments of the present invention employing mechanical reels may use a serial interface device such as serial interface 211 to control communications with the reel assembly, and may not include a direct bus interconnection as indicated by FIG. 2. Details of a mechanical reel arrangement and various accent lighting arrangements that may be associated with mechanical reels are not shown in the present figures so as to avoid obscuring the present invention in unnecessary detail.

Referring now to FIG. 3, a networked gaming system 300 associated with one or more gaming facilities may include one or more networked gaming machines 100 (shown in FIG. 3 as EGM1-EGMn) connected in the network by suitable network cable or wirelessly. Networked gaming machines 100 and one or more overhead display devices 313 may be operatively connected so that the overhead display device or display devices may mirror or replay the content of one or more displays of gaming machines 100. For example, the primary display content for a given gaming machine 100 (including a base game portion and bonus features according to the present invention) may be transmitted through network controller 210 to a controller associated with the overhead display device(s) 313. In the event gaming machines 100 have cameras installed, the respective player's video images may be displayed on overhead display device 313 along with the content of the player's gaming machine display device.

The example gaming network 300 shown in FIG. 3 includes a host server 301 and floor server 302, that together may function as an intermediary between floor devices such as gaming machines 100 and back office devices such as the various servers described below. Game server 303 may provide server-based games and/or game services to network connected gaming devices such as gaming machines 100. Central determinant server 305 may be included in the network to identify or select lottery, bingo, or other centrally determined game outcomes and provide the outcome information to networked gaming machines 100 that present the games to players.

Tournament server 306 may be included in the system for controlling or coordinating tournament functions. These functions may include maintaining tournament player scores and ranking during the course of tournament play and communicating this information to the various gaming machines 100 participating in the tournament. Tournament server 306 may also function to enroll players in tournaments, schedule tournaments, and maintain the time remaining in the various tournaments.

Progressive server 307 may maintain progressive pools for progressive games available through the various gaming machines 100 (such as some prizes defined for the bonus feature options described further below). In some implementations, progressive server 307 may simply receive communications indicating contribution amounts that have been determined by processes executing at the various gaming machines 100 or elsewhere in the gaming network. Alternatively, progressive server 307 may perform processes to determine the contribution amounts for incrementing the various progressive pools that may be maintained. Progressive server 307 may also periodically communicate current pool values back to the various gaming machines 100 and may participate in communicating awarded progressive prize amounts to the gaming machines and making adjustments to the progressive prize pools accordingly. In some implementations, progressive server 307 may also determine or participate in determining when a progressive prize triggering event occurs.

Accounting server 311 may receive gaming data from each of the networked gaming devices, perform audit functions, and provide data for analysis programs. Player account server 309 may maintain player account records, and store persistent player data such as accumulated player points and/or player preferences (for example, game personalizing selections or options).

Example gaming network 300 also includes a gaming website 321 hosted through web server 320 and accessible by players via the Internet. One or more games may be displayed as described herein and played by a player through a personal computer 323 or handheld wireless device 325 (for example, an Android® operating system smart phone, Apple® iPhone® smart phone, personal digital assistant (PDA), iPad® or other tablet computer, etc.). To enter website 321, a player may log in with a user name that may, for example, be associated with the player's account information stored on player account server 309. Once logged in to website 321 the player may play various games on the website, including games according to the invention. Also, website 321 may allow the player to make various personalizing selections and save the information so it is available for use during the player's next gaming session at a casino establishment having the gaming machines 100.

It will be appreciated that gaming network 300 illustrated in FIG. 3 is provided merely as an example of a gaming network which may facilitate multiple bonus feature path games according to aspects of the present invention and is not intended to be limiting in any way. Gaming machines controlled according to aspects of the present invention are not limited to use with gaming networks such as network 300.

FIG. 4 shows an example process of controlling a gaming machine to provide multiple bonus features in accordance with aspects of the present invention. The illustrated method includes initializing the EGM (such as gaming machine/EGM 100 shown in FIGS. 1 and 3) at process block 402 and then receiving a game play activation input as shown at process block 404. Initializing the gaming machine as indicated at process block 402 in FIG. 4 comprises any process needed in the given implementation and at a given instance of the process shown in the figure to place the gaming machine in a state for receiving the play activation input. The game play activation input (which may also be referred to herein simply as a “play input”) indicated at process block 404 may be received in any suitable fashion, such as, for example, through a player actuated control such as a “Play” button or lever. Each game play input may be associated with a wager selected or entered by the player through a suitable control included in the player input system as part of the initializing process shown at process block 402. The wager may be a monetary value, a credit value that may equate to a monetary value or point value that does not equate to any monetary value. Other implementations, including implementations through gaming machines other than casino-style gaming machines such as that shown in FIG. 1, may not require a wager for initializing the gaming machine as shown at process block 402 for receiving a game play input as shown at process block 404.

In response to the game play input, the process includes causing the display system associated with the gaming machine to display a result for a base portion of the game as shown at process block 406. As will be described in the specific example shown in FIG. 5, this display of the base portion result may include controlling the gaming machine display system to display populating the game symbol locations in an initial array of game symbol locations. Regardless of the manner in which the base portion result is displayed, the displayed base portion result is selected from a number of potential base portion results that include both a first trigger condition and a second trigger condition.

In the event the first trigger condition is present in the base portion result as indicated by an affirmative outcome at decision box 407, the process proceeds to display the first bonus feature reel activations as shown at process block 408. Although the first trigger condition in the base portion result may be any suitable condition, implementations of the invention may define the first trigger condition as a condition in which each of the symbol locations defining a full column in an array of game symbol locations includes a particular bonus symbol and preferably a wild symbol. Such an implementation will be described below in connection with FIG. 5.

In the event the first trigger condition is not present in the base portion result, the process proceeds to decision box 409 to determine if the second trigger condition is present in the base portion result. Where the second trigger condition is present in the base portion result, the process continues on to display a selection from the available additional bonus feature options as indicated at process block 410. In the event the reel-type bonus is selected in the selection at process block 410, the process proceeds from decision box 411 to display the second bonus feature reel activations as indicated at process block 412. Otherwise, where another one of the additional bonus features is selected at process block 410, that other bonus feature is displayed as shown at process block 414. After the first bonus feature, second bonus feature, or other additional bonus feature is conducted, the process may cause the display system to transition back to the base portion graphic state as indicated at process block 415. From process block 415 or in the event neither the first trigger condition nor second trigger condition is present in the base portion result, the illustrated example process continues on to determine if a cash out is selected as indicated at decision box 416. If the player has requested a cash out, the process continues to the cash out process indicated at process block 417 and otherwise returns to initialize the gaming machine as necessary for another game play input in the base portion of the game at process block 402.

In the process flow indicated in FIG. 4, initializing the processes at blocks 402, 404, 406 and decision boxes 407 and 409 may be conducted under the control of base game program code executed at a processing system associated with a gaming machine such as gaming machine 100 shown in FIG. 1. The selection indicated at process block 410 and decision at decision box 411 may be conducted under the control of bonus feature selection program code executed at the processing system. Each of the different bonus features indicated at process blocks 408, 412, and 414 may be conducted under the control of respective bonus feature program code executed at the processing system. Any award of prizes for the given activation of the gaming machine may be conducted under the control of prize assignment program code executed by the processing system.

As with the first trigger condition detected at box 407, the second trigger condition detected at decision box 409 may comprise any suitable condition in the base portion result that is identifiable to the player. Where the base portion result is displayed as an array of symbol locations from a simulated or actual reel spin, the second trigger condition may comprise the presence of one or more special game symbols at a particular location or at any location in the array of symbol locations. For example, the second trigger condition may comprise three game symbols defined as second trigger symbols located at any positions in the array displaying the base portion result.

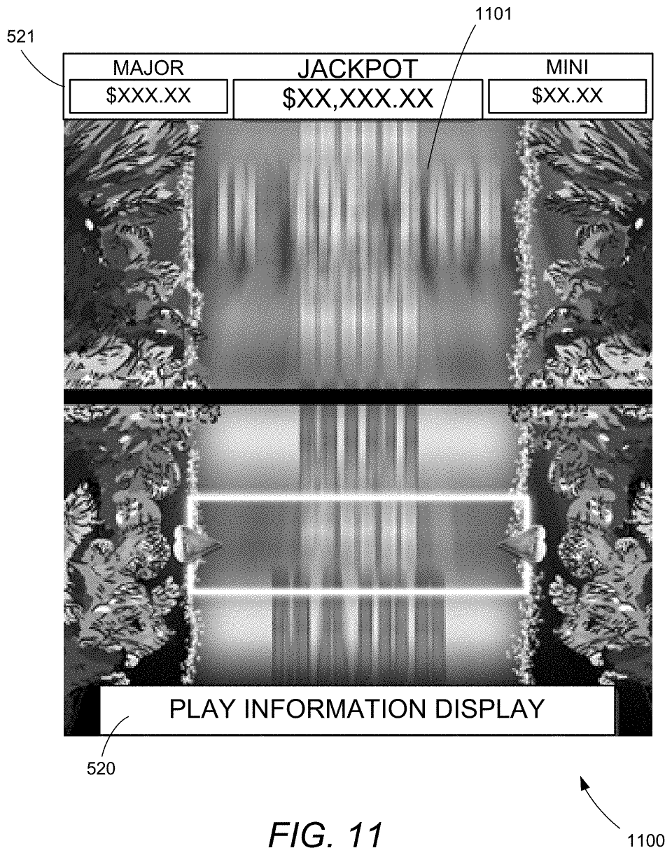

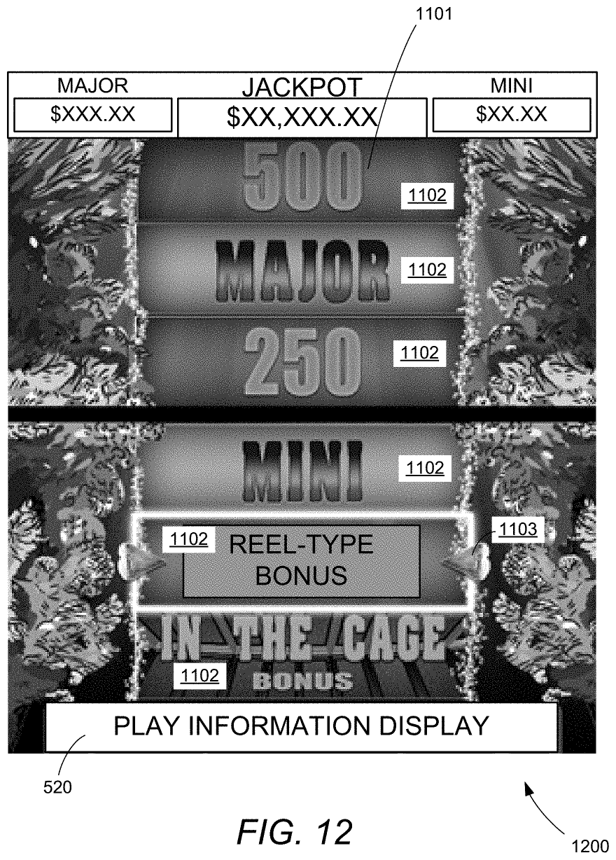

The selection displayed at process block 410 may include the rotation of a selection device such as a segmented wheel or reel. The different options for the additional bonus feature may be defined as the various segments on such a selection device. As will be discussed below in connection with the example illustrations of FIGS. 11 and 12, the various options which may be selected in the process indicated at process block 410 may include not only bonus features that are then conducted but also predefined prize awards or progressive prize awards.

The transition to the base portion graphic state indicated at process block 415 will depend upon the bonus feature or award conducted or displayed according to process blocks 408, 412, or 414 for the given play in the game resulting from the game play input at block 404. In the case of the first bonus feature in which the same game symbol location array is used for both the activations at 408 and for the display of the base portion result at 406, the transition may maintain the array of game symbol locations but modify surrounding graphic elements. However, where the second bonus feature is conducted as indicated at process block 412 with the expanded array of game symbol locations, the transition at process block 415 may include a graphic transition to eliminate the rows and/or columns of symbol locations added to produce the second, expanded array of game symbol locations. The transition at 415 after a process at process block 414 will depend upon the nature of the bonus feature conducted at that process. For example, in the case where the selection selects a predefined prize or a progressive prize, that selected prize is awarded and then the display transitions from the selection display back to the base portion graphic state. Otherwise, where some other type of second bonus feature is displayed at process block 414, the transition at block 415 includes transitioning from the end graphic condition of that particular bonus feature back to the base portion graphic state.

FIG. 5 provides a representation of a graphic display 500 shown at a display system of a gaming machine such as gaming machine 100 for an implementation of a base portion of a game in accordance with the present invention. This display may be shown for example on the main the display device 104 of the example gaming machine 100 shown in FIG. 1. Other gaming machines may include two smaller display devices in the place of display device 104 in FIG. 1 and the graphic display shown in FIG. 5 may be divided across those display devices. For example, gaming machine may include a display device one over the other in the place of single display device 104 and the graphic portion shown above the divider line 501 in FIG. 5 (which comprises a bezel break between the two vertically aligned display devices in that example) may be shown on the upper one of those display devices while the portion below that divider line may be shown on the lower one of those display devices.

Example graphic display 500 shown in FIG. 5 includes an array 502 of game symbol locations 504 comprising four rows 506, 507, 508, and 509 and five columns 511, 512, 513, 514, and 515. Each of the columns 511-515 of game symbol locations 504 may be defined by a single physical or simulated reel although it is possible for an implementation to include a separate physical or simulated reel for each game symbol location 504. Background graphic area 517 is included in this example to show background graphics around array 502, while an upper background graphic area 518 shows background graphics above the array 502. The symbols shown in the illustrated array 502, for example, F6 at row 506, column 511 and F5 at row 507, column 511 represent game symbols selected from a number of such symbols available for populating a given game symbol location 504 in the base portion of the game. The symbol “Wld” shown FIG. 5 at a number of symbol locations 504 each represents a wild symbol. Of course, these symbols shown in FIG. 5 are simply placeholders for game symbols that may be defined for the base portion of the game and any type of graphic symbols may be used for the game symbols for a given implementation.

In addition to array 502 of same symbols 504 and background graphic areas 517 and 518, graphic display 500 shown FIG. 5 includes a play information display 520 at the bottom of the graphic display. This play information display 520 may include a number of separate windows to display various information for the play of the game. For example, play information display 520 may include a separate window for the player's remaining credits, a separate window to show the current the win credit value for a current activation of the game, and separate windows or areas showing the game denomination, a bet multiplier, and a current bet, for example. Play information display 520 may also include an icon that may be selected in a suitable fashion to cause explanatory information to be displayed at a suitable location or locations in the area of display 500 or some other display area at the gaming machine.

The example display 500 shown FIG. 5 also includes a progressive prize information display indicated generally at 521 at the top of the overall display area. This particular example game includes three different progressive prize levels titled JACKPOT, MAJOR, and MINI. The respective window associate with each progressive prize shows the progressive prize value at a given point in time. These progressive values are represented as variables in the example of FIG. 5, although in an actual implementation the values are preferably numerical values and are updated periodically as the progressive prize pools change over the course of play.

The state of the array 502 of symbol locations 504 in the example of FIG. 5 shows a respective wild symbol “Wld” located in each symbol location of the fourth column, column 514. This condition comprising a given column in the array 502 populated entirely with wild symbols (a first bonus stacked symbol group) may be defined as the first trigger condition in accordance with the present invention. In the example display 500 of FIG. 5, each of the wild symbols is shown modified graphically to indicate that the first trigger condition has been met.

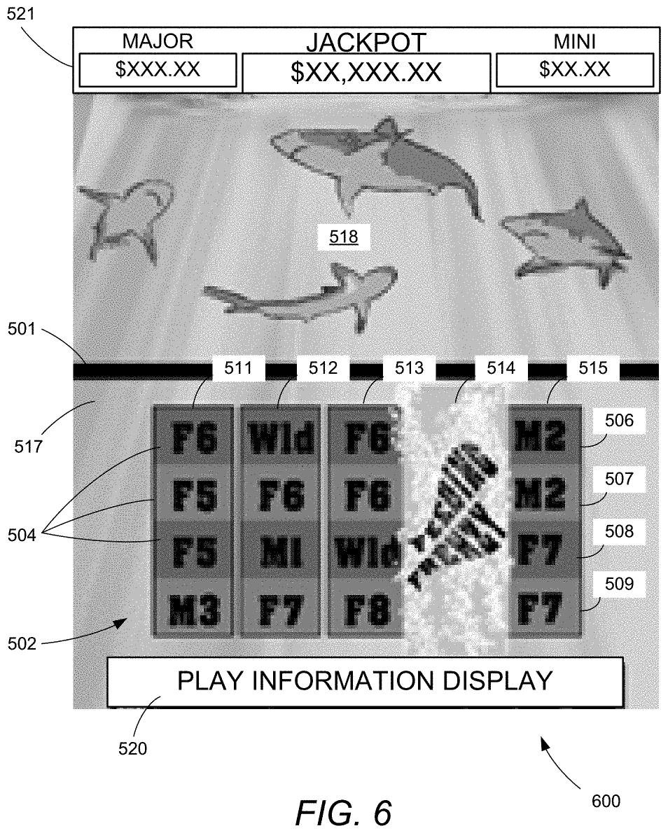

FIG. 6 shows a representation of a graphic display 600 to which the display 500 shown FIG. 5 may transition for the conduct of the first bonus feature in response to the presence of the first trigger condition in the base portion array 502. In this example, the play information display 520 and progressive jackpot display 521 remains the same as in the previous presentation; however, the background graphics in areas 517 and 518 for the game symbol array 502 have been modified in this case to show a series of graphic elements, in this case sharks, circling in area 518. The array 502 itself remains unchanged from that used to display a result in the base portion of the game in terms of the number of rows and columns defining the array. The wild symbols in column 514 in this example have been replaced with a wild column graphic 602 that covers each symbol location in the column although each covered symbol location is preferably still considered as containing a wild symbol for purposes of evaluating the array 502 for winning symbol combinations and the column still represents the first bonus stacked symbol group. In this example, the state of the array 502 shown in FIG. 6 is the state immediately preceding the first activation of the reels for the first bonus feature.

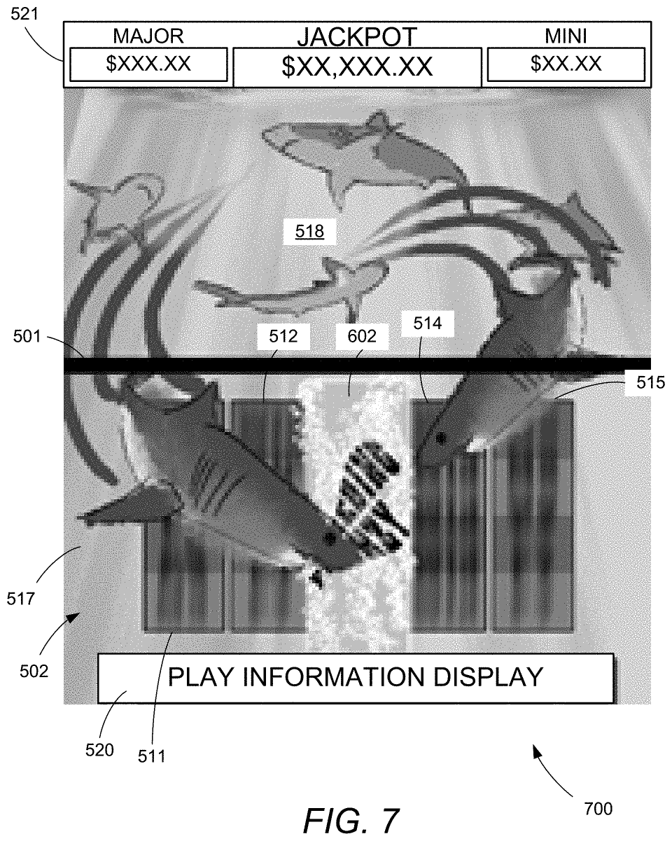

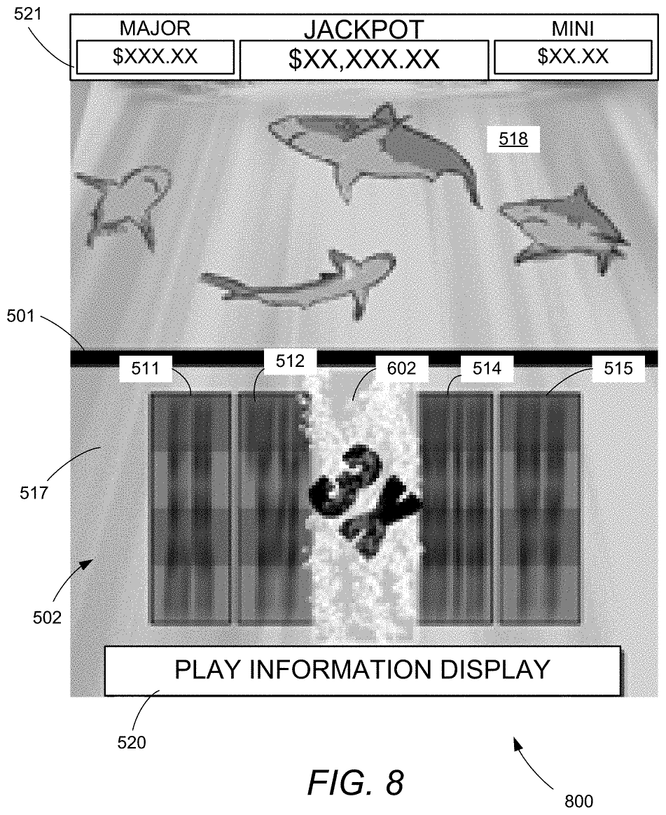

FIG. 7 shows a representation of a graphic display 700 at a point in time after that shown in FIG. 6 and after the first activation of the reels defining array 502 in the first bonus feature. Each of the reels defining columns 511, 512, 514, and 515 is shown spinning in FIG. 7. The wild column graphic 602 has moved in a column movement direction to the third column 513 for this first activation, and remains at that location for evaluating the array 502 for the first activation. In this particular implementation of the invention, the sharks in the display may be shown occasionally dropping down from area 518 and interacting with the wild column symbol 602 with each such interaction increasing a multiplier associated with the column and with the given activation. The graphic display 800 of FIG. 8 shows state of array 502 similar to that shown in FIG. 7 while the reels remain spinning for the first activation of the reels in the example first bonus feature. However, in FIG. 8 the wild column symbol 602 shows a 3× multiplier from the interaction with the sharks as shown in FIG. 7.

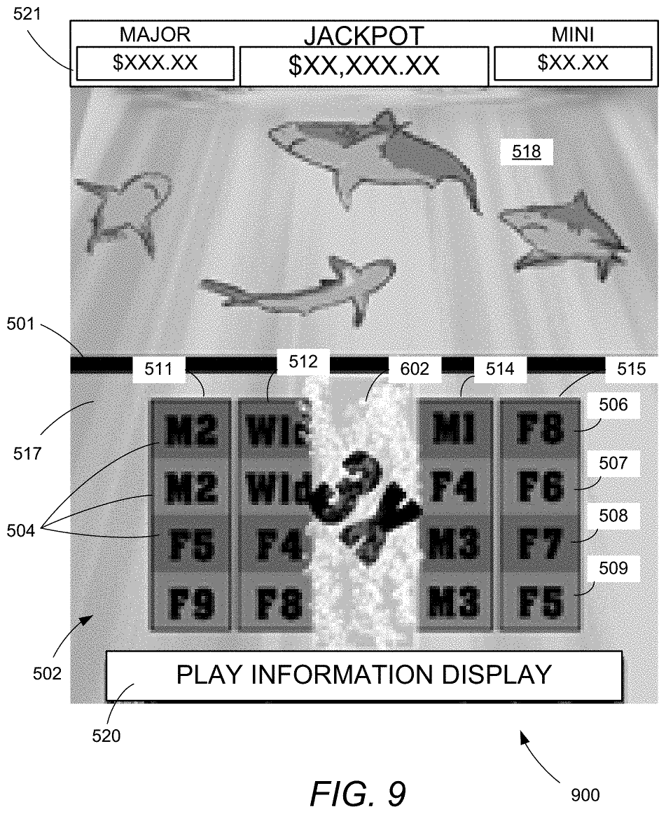

FIG. 9 shows a representation of a display 900 at a point in time after the state shown FIG. 8. In the state shown in FIG. 9, the reels have come to rest showing specific game symbols populating each game symbol location 504 defined by the array 502 aside from the column containing the special wild column symbol 602 and multiplier. This condition shown in FIG. 9 represents a first bonus feature activation result comprising the result for the initial activation in the example first bonus feature. At this point in the process, any winning patterns of game symbols located in array 502 may be highlighted and the win meter that may be included in play information display 520 may be incremented showing the credit values awarded for the winning symbol patterns and multiplier.

From the condition of array 502 shown in FIG. 9, a second activation of the reels forming the array is conducted for the reels defining columns 511, 513, 514, and 515, while the wild column symbol 602 transitions over to the second column, column 512. Each of the reels that spin for this activation, columns 511, 513, 514, and 515 eventually come to rest for the activation to populate the symbol locations 504 of those columns with game symbols. This resulting array of game symbols is then evaluated and any winning symbol patterns awarded as described in connection with FIG. 9. As with the first activation of the reels described above, the sharks may drop down from area 518 during the spin and interact with the wild column symbol 602 to incremented a multiplier associated with that spin/activation of the reels. The multiplier may be carried over from one activation to another or zeroed out and start anew for each activation of the reels in the first bonus feature. The reel activations continue in this fashion until the wild symbol column 602 reaches the first column in the array. The spin in which the wild symbol column 602 reaches the first column in the array, column 511, represents the final activation of the array for the first bonus feature assuming no re-triggering of the first bonus feature has occurred or is allowed in the particular implementation.

In some implementations of the first bonus feature, the first bonus feature may be re-triggered for additional reel activations in any of the first bonus feature reel activations. A re-triggering may be defined as occurring when a given column in the array 502 includes symbol locations all populated a wild symbol for a given activation during the first bonus feature. Where such a re-triggering has occurred, that wild symbol column may transition to the wild column symbol 602 as shown in FIGS. 6-9 and that symbol transitions across the array in the column movement direction, to the left in the present example, for each activation in the first bonus feature. In this example, the first bonus feature may end when the last wild column symbol 602 has reached the first column 511 and no further wild symbol columns are present in the array 502.

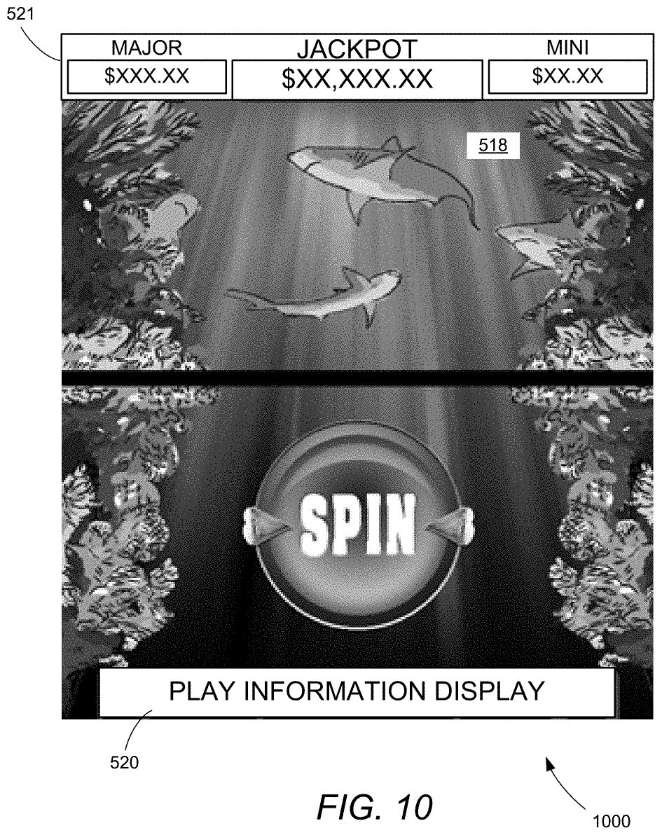

FIG. 10 shows a graphic display 1000 that may be shown on a display device such as display device 104 in FIG. 1 in response to a second trigger condition present in the base portion result for the game. In particular, the base portion display 500 shown in FIG. 5 (without the first bonus feature trigger shown that figure) may transition to display 1000 shown in FIG. 10 in response to a second trigger condition associated with the array 502 in FIG. 5. This particular display 1000 utilizes a player input either on a touch-screen showing the “SPIN” symbol or some other input to initiate the indicated process of selecting an additional bonus game. This selection corresponds to the selection shown at process block 410 in FIG. 4. Some implementations employing the display 1000 or similar display as a starting point for the selection of the additional bonus feature may also initiate the spin/selection display upon passage of a predefined period of time after the display 1000 is shown at the display system. Other implementations may not show a display such as 1000 and instead may transition automatically to the selection display such as that shown in FIGS. 11 and 12.

FIG. 11 shows representation of a display 1100 that may be used to show the selection indicated at process block 410 in FIG. 4. In this example, display 1100 is produced by the gaming machine display system after the “SPIN” display 1000 shown in FIG. 10. The selection in this example implementation is shown to the player via the spin of a simulated reel shown generally at 1101 in FIG. 11. FIG. 11 shows the simulated reel 1101 spinning while FIG. 12 shows the reel 1101 after it has come to rest. As shown best by the state of the reel 1101 in FIG. 12, the example reel includes individual segments that together define a single column of segment locations 1102 in the display. In this particular example, the segments available for selection include predefined prize values such as 500 credits in 250 credits, the progressive prizes shown in progressive prize display 521 (MAJOR and MINI shown in this stop position), and various additional bonus features. The particular stop position shown in FIG. 12 displays segments for a REEL-TYPE BONUS and a bonus feature referred to as the IN THE CAGE BONUS. Other additional types of bonus features may be available in other implementations according to the present invention. In this example, FIG. 12 shows the REEL-TYPE BONUS aligned with selection symbols 1103. Having thus been selected according to the process shown at 410 in FIG. 4, the REEL-TYPE BONUS will be conducted as the second bonus feature for this particular play in a game controlled in accordance with the present invention.

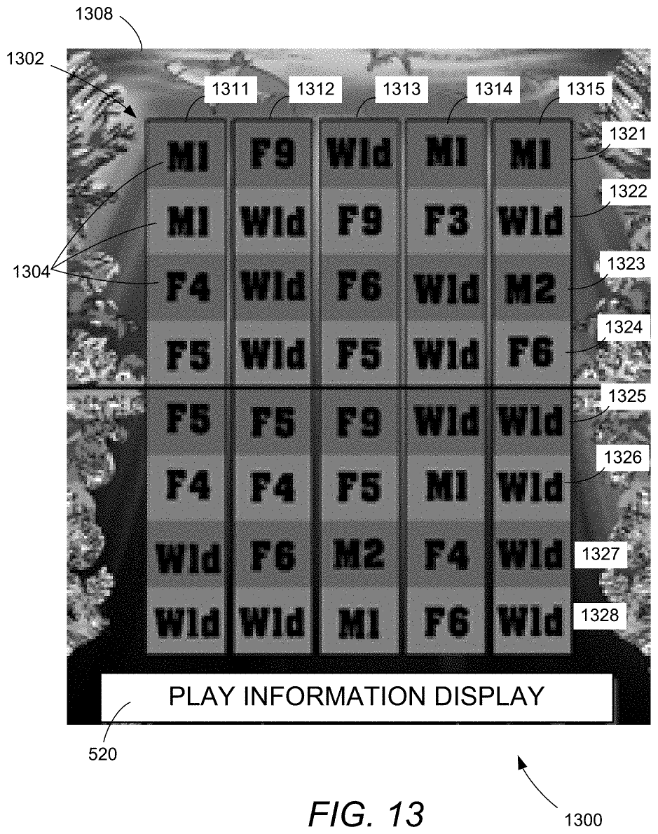

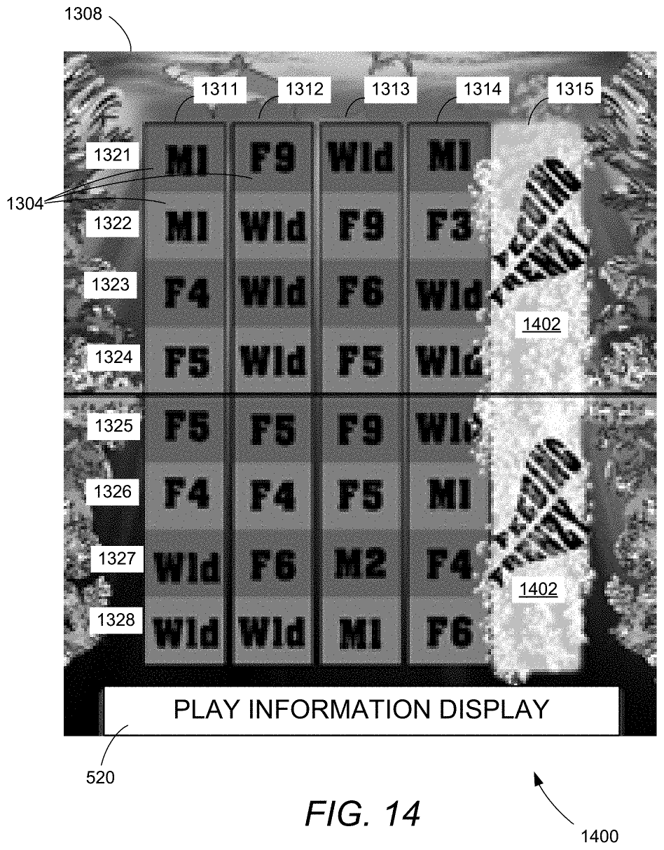

In the illustrated example game, the display 1200 shown in FIG. 12 transitions in some suitable fashion to show a second array 1302 of game symbol locations 1304 included in display 1300 shown in FIG. 13. In this example, the second array 1302 of game symbol locations 1304 doubles the number of game symbol locations as compared to array 502 employed to display the base portion results and the results of individual activations in the first bonus feature. Thus second array 1302 includes symbol locations 1304 defining five columns 1311-1315 and eight rows 1321-1328 of game symbol locations. It is noted that in FIG. 13 the progressive prize display portion (1521 in FIG. 5 for example) is not included in display 1300 in this example because the progressive prizes are not available as a result in this particular second bonus feature and the progressive prize display portion would interfere with the expanded second array 1302 and graphics described below. The various game symbols such as M1 at row 1321, column 1311 and F9 at row 1321, column 1312, are placeholders similar to those shown in FIG. 5. The game symbols defined for a given implementation of the reel-type second bonus feature may comprise any suitable game symbols and may be selected from the same game symbol set used for the base portion of the game and first bonus feature or a different game symbol set. Column 1315 in this example embodiment is controlled to include the same trigger condition that comprises the first trigger condition described above in connection with FIG. 5 for the first bonus feature. Namely, each symbol location 1304 of the four bottom rows 1325-1328 of column 1315 is initially populated for the play of the second bonus feature with a respective wild symbol (a second bonus stacked symbol group). From the state of display 1300 shown FIG. 13, this particular example embodiment controls the display system (such as 104 in FIG. 1) to transition to the display 1400 shown in FIG. 14 in which a wild column symbol 1402 replaces the individual symbols in all rows 1321-1328 of column 1315 in array 1302.

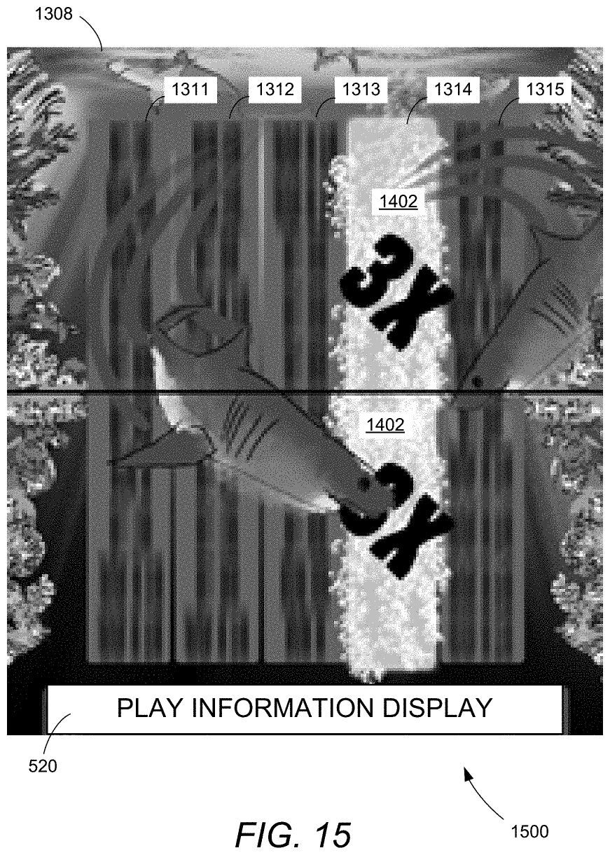

From the starting point for reel activations in the reel-type second bonus feature shown in FIG. 14, the second bonus feature may be conducted similarly to the first bonus feature described above in connection with FIGS. 6-9. However, the expanded array 1302 of game symbol locations 1304 for the second bonus feature may define many additional paylines which may be evaluated for winning game symbol combinations defined for the game. FIG. 15 shows a display 1500 in this example second bonus feature after the reels defining columns 1311-1315 begin spinning and wild column symbols 1402 moves in the column movement direction (to the left in the figure) from column 1315 to column 1314 in the course of the spin similarly to the conduct of the first bonus feature. In this example, the sharks shown in the display in the more limited area 1308 above array 1302 may be shown as interacting with the wild column symbols 602 to show a multiplier associated with the given activation. From the state of the display 1500 shown in FIG. 15, each of the reels remaining spinning, in this case the reels defining columns 1311-1313 and 1315 will eventually come to rest showing game symbols in each of the symbol locations (1304 in FIGS. 13 and 14), any prizes defined by the symbol patterns shown in array 1302 will be awarded for that activation similarly to the first bonus feature described above. The activations of this expanded array 1302 continue as described above for the first bonus feature until the wild column symbols 1402 reach the first column 1311 in the array. As described above for the first bonus feature, the second bonus feature may re-trigger with wild symbols populating the array 1302 to fill rows 1321-1324 or rows 1325-1328 in a given column. If re-triggered, the activations of the expanded array 1302 will continue until the last remaining wild column symbol 1402 reaches the first column 1311 of the array. At that point the any winning symbol combinations shown in the array for that last activation will be awarded and then the display will transition back to the base portion graphic state.

Implementations within the scope of the present invention may include a number of variations on the specific examples described above in connection with FIGS. 5-15. For example, the first trigger condition and second trigger condition may be defined as any conditional apparent in the base portion result or even as a mystery trigger which is not apparent to the player from the base portion result. Also, any size of array and reel arrangement for showing the array of symbol locations may be used in the first and second bonus features. Furthermore, even though it is desirable for the base portion of the game to display results via the same array of symbol locations used for the first bonus feature activations, the base portion of the game may show result via a different array of symbol locations and even via an arrangement other than actual or simulated reels. With regard to the individual activations of reels for the first bonus feature and second bonus feature, the activations may be automatic without any input from the player or in response to a player input or in response to a time-out condition for receiving a player input.

Implementations within the scope of the present invention also encompass many variations within the conduct of the first and second bonus features. For example, while the above-described example controls the wild column symbol to move in the column movement direction as part of the first activation in the bonus feature, implementations may begin this column movement on the second activation. It is also possible that the wild column is not controlled to move in the column movement direction on each activation, but only activations according to some predefined condition or mystery condition not apparent to the player. Implementations may also not use a symbol column that moves across the array and may use some other process for determining the number of reel activations for the given reel-type bonus feature.

Outcomes in the base portion of the game, first and second bonus features, and any other bonus feature employed in a given implementation may be generated or obtained in any suitable fashion. In some implementations, the outcome for a given play in the game may be randomly determined first and then the base portion of the game, first bonus feature, second bonus feature or other bonus feature controlled to display that outcome. In other implementations, the various game elements such as reels may be stopped randomly to effectuate a desired prize distribution and then the resulting graphics, such as an array of game symbols, evaluated to identify any prizes to be awarded. The reference to a random determination here or random stopping of reels may refer to a true random determination or a pseudo-random determination based on a suitable algorithm. The term “random” in this disclosure and any use in the accompanying claims is intended to encompass true random and pseudo-random.

FIG. 16 comprises a block diagram of software and data structures that may be employed to implement multiple bonus feature paths in accordance with aspects of the present invention where the outcome for a given activation is obtained first according to some random or pseudo-random process and then the display system is controlled to show the randomly selected outcome. The block diagram of FIG. 16 shows an arrangement 1602 for generating a first random number, an arrangement 1604 for obtaining an outcome based on that first random number, and an arrangement 1606 for generating a second random number. The outcome from 1604 is used to select an outcome script set 1608 corresponding to that outcome and the second random number from 1606 is used to select an outcome script for the given activation of the game. Game engine 1610 is operable to execute the selected outcome script to control the gaming machine display system to display the randomly selected outcome using media assets 1612 from an arrangement for storing such assets.

For centralized gaming architectures, a device such as a central determinant server (305 in FIG. 5 for example) may comprise the random number generating arrangement 1602. In such a centralized gaming architecture, the gaming machine may request a random number in response to an activation input (as shown at 404 in FIG. 4), and the central determinant server may include a random number generator that communicates the first random number to the gaming machine in response to the request. In many Class III type gaming systems, the random number generating arrangement 1602 comprises a random number generator at the gaming machine itself. In either case the random number generator may be a hardware-based random number generator or other random number generator conforming to applicable regulations for both security and randomness.

The arrangement 1604 for selecting an outcome based on the random number from block 1602 may likewise reside at a centralized device such as a central determinant server in a centralized gaming architecture or at the gaming machine itself In either case the arrangement 1604 may select an outcome by using the first random number from 1602 to select from a pool of available outcomes to produce a desired prize distribution and payout percentage. The selected outcome has a possibility of including only the base portion result or both a base portion prize and a bonus feature prize for any of the bonus features offered in the given implementation. This includes any progressive prizes available in the given implementation such as the “MINI,” “MAJOR,” and “JACKPOT” prizes noted in the above example.

The second random number generating arrangement 1606 in the example of FIG. 16 comprises any suitable arrangement for generating a second random number. Where the gaming machine includes the arrangement 1602 for generating the first random number, the arrangement 1606 may comprise the same random number generator used to generate the first random number. Regardless of which specific element in the system is used to generate the second random number, that second random number is used in this example implementation of FIG. 16 together with the outcome selected at 1604 to select a specific outcome script to display the outcome at the gaming machine. Specifically, the gaming machine uses the outcome from 1604 to select an outcome script set 1608 that includes outcome scripts to show that particular outcome, that is, the prize associated with that outcome. The gaming machine also uses the second random number from block 1606 to select a specific one of the outcome scripts in the selected outcome script set 1608. For example, if the outcome correlates to a prize of 200 credits, the set 1608 containing scripts showing a total 200-credit prize for the given activation of the gaming machine is selected and the second random number is use to select one of these scripts. As another example, if the outcome correlates to a prize of 500 credits, the set 1608 containing scripts showing a total 500-credit prize for the given activation of the gaming machine is selected and the second random number is used to select one of these scripts. The given script selected from a set 1608 may show only the base portion of the game, or the base portion of the game and one of the bonus features. Thus the total prize for the activation of the gaming machine may be shown as only a base portion prize with no prize from a bonus feature, or only a bonus feature prize with no prize amount from the base portion, or a total made up of a prize amount from the base portion of the game and a prize amount from a bonus feature of the game.

The specific script selected from the set 1608 for the prize to be awarded is then loaded to the game engine 1610 and executed to cause the display system to display the desired graphics. The game engine 1610 may, for example, include a JavaScript® Object Notation (JSON) script engine that receives the data from 1608 in JSON format and then interprets and executes the instructions contained in the received data. Of course, although the example shows a JSON script engine, the invention is certainly not limited to JSON or any other data interchange format or language. Regardless of the nature of game engine 1610, it may access media assets 1612 stored in the game software at the gaming machine or elsewhere in a networked system and use these media assets to cause the gaming machine display system to display the game outcome in accordance with the present invention. The media assets 1612 may include data structures for simulated reels used in the base portion of the game and the first and second bonus reel feature and thus represent the program code for conducting the base portion of the game and bonus features. Other media assets 1612 may include a data structure (bonus feature selection program code) for the second bonus feature selection indicated at process block 410 in FIG. 4.

As used herein, whether in the above description or the following claims, the terms “comprising,” “including,” “carrying,” “having,” “containing,” “involving,” and the like are to be understood to be open-ended, that is, to mean including but not limited to. Also, it should be understood that the terms “about,” “substantially,” and like terms used herein when referring to a dimension or characteristic of a component indicate that the described dimension/characteristic is not a strict boundary or parameter and does not exclude variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

Any use of ordinal terms such as “first,” “second,” “third,” etc., in the following claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

In the above descriptions and the following claims, terms such as top, bottom, upper, lower, and the like with reference to a given feature are intended only to identify a given feature and distinguish that feature from other features. Unless specifically stated otherwise, such terms are not intended to convey any spatial or temporal relationship for the feature relative to any other feature.

The term “each” may be used in the following claims for convenience in describing characteristics or features of multiple elements, and any such use of the term “each” is in the inclusive sense unless specifically stated otherwise. For example, if a claim defines two or more elements as “each” having a characteristic or feature, the use of the term “each” is not intended to exclude from the claim scope a situation having a third one of the elements which does not have the defined characteristic or feature.

The above-described preferred embodiments are intended to illustrate the principles of the invention, but not to limit the scope of the invention. Various other embodiments and modifications to these preferred embodiments may be made by those skilled in the art without departing from the scope of the present invention. For example, in some instances, one or more features disclosed in connection with one embodiment can be used alone or in combination with one or more features of one or more other embodiments. More generally, the various features described herein may be used in any working combination

1. A method for controlling multiple bonus features in a gaming machine, the method including:
(a) under control of a processing system associated with the gaming machine, causing a display system of the gaming machine to display a base portion of a game in response to a play activation input received at the gaming machine, the display of the base portion of the game including displaying a base portion result comprising one of a number of potential base portion results where at least one respective potential base portion result includes a first trigger condition and at least one respective potential base portion result includes a second trigger condition;
(b) where the base portion result includes the first trigger condition, conducting a first bonus feature under control of the processing system;
(c) in conducting the first bonus feature, (i) causing the display system to display a number of reels to produce a first array of game symbol locations having at least two rows and at least two columns, and (ii) causing the display system to display a number of activations of the reels which produce the first array, each activation populating at least some of the game symbol locations of the first array with a respective game symbol from a set of game symbols for the first bonus feature to produce a respective first bonus feature activation result, and (iii) for each first bonus feature activation result, awarding any prize defined for any pattern of game symbols present in the first array of game symbol locations for that first bonus feature activation result;
(d) where the base portion result includes the second trigger condition, causing the display system to display a selection from among a number of different bonus feature options under control of the processing system, the number of different bonus feature options including a reel-type bonus feature option, and where the selection identifies the reel-type bonus feature option, conducting a second bonus feature under control of the processing system; and
(e) in conducting the second bonus feature, (i) causing the display system to display a number of reels to produce a second array of game symbol locations larger than the first array of game symbol locations, and (ii) causing the display system to display a number of activations of the reels which produce the second array, each activation populating at least some of the game symbol locations of the second array with a respective game symbol from a set of game symbols for the second bonus feature to produce a respective second bonus feature activation result, and (iii) for each second bonus feature activation result, awarding any prize defined for any pattern of game symbols present in the second array of game symbol locations for that second bonus feature activation result.

2. The method of claim 1 wherein:
(a) displaying the base portion of the game includes causing the display system to display a base portion activation of the reels which produce the first array of game symbol locations, the base portion activation populating at least some of the game symbol locations of the first array with a respective game symbol from a set of game symbols for the base portion of the game; and
(b) the first trigger condition comprises a state of the first array in response to the base portion activation in which a column of game symbol locations in the first array comprises a first bonus stacked symbol group in which each game symbol location in that column of game symbol locations displays a respective first bonus symbol.

3. The method of claim 2 wherein in conducting the first bonus feature, for a respective activation of the reels which produce the first array, causing the display system to display each respective first bonus symbol in the first bonus stacked symbol group moving one column in a column movement direction.

4. The method of claim 3 wherein the first bonus feature ends upon awarding any prize for the activation where the first bonus stacked symbol group, or a different such first bonus stacked symbol group which has landed in the first array, resides in a final column in the column movement direction.

5. The method of claim 3 wherein displaying the selection from among the number of different bonus feature options comprises a rotation of a selection element where the number of different bonus feature options are defined at different segments of the selection element.

6. The method of claim 5 wherein:
(a) for a respective activation of the reels which produce the second array, the second array includes a column of game symbol locations which comprises a second bonus stacked symbol group in which each game symbol location in that column displays a respective second bonus symbol; and
(b) for a respective activation of the reels which produce the second array, conducting the second bonus feature includes causing the display system to display each respective second bonus symbol in the second bonus stacked symbol group moving one column in a column movement direction.

7. The method of claim 6 wherein the second bonus feature ends upon awarding any prize for the activation where the second bonus stacked symbol group, or a different such second bonus stacked symbol group which has landed in the second array, resides in a final column of the second array in the column movement direction.

8. The method of claim 6 wherein the second array of game symbol locations defines twice as many rows as the first array of game symbol locations.

9. A gaming machine including:
(a) a player input system;
(b) a display system;
(c) a processing system including at least one processor; and
(d) at least one memory device storing instructions executable by the processing system to:
(i) cause the display system to display a base portion of a game in response to a play activation input from the player input system, the display of the base portion of the game including a base portion result selected from a number of potential base portion results where at least one respective potential base portion result includes a first trigger condition and at least one respective potential base portion result includes a second trigger condition;
(ii) where the base portion result includes the first trigger condition, conduct a first bonus feature;
(iii) in the conduct of the first bonus feature, cause the display system to display a number of reels to produce a first array of game symbol locations having at least two rows and at least two columns, and cause the display system to display a number of activations of the reels which produce the first array, each activation populating at least some of the game symbol locations of the first array with a respective game symbol from a set of game symbols for the first bonus feature to produce a respective first bonus feature activation result, and for each first bonus feature activation result, award any prize defined for any pattern of game symbols present in the first array of game symbol locations for that first bonus feature activation result;
(iv) where the base portion result includes the second trigger condition, cause the display system to display a selection from among a number of different bonus feature options, the number of different bonus feature options including a reel-type bonus feature option, and where the selection identifies the reel-type bonus feature option, conducting a second bonus feature under control of the processing system; and
(v) in the conduct of the second bonus feature, cause the display system to display a number of reels to produce a second array of game symbol locations larger than the first array of game symbol locations, and cause the display system to display a number of activations of the reels which produce the second array, each activation populating at least some of the game symbol locations of the second array with a respective game symbol from a set of game symbols for the second bonus feature to produce a respective second bonus feature activation result, and for each second bonus feature activation result, award any prize defined for any pattern of game symbols present in the second array of game symbol locations for that second bonus feature activation result.

10. The gaming machine of claim 9 wherein:
(a) the display of the base portion of the game includes causing the display system to display a number of reels to produce the first array of game symbol locations and to display a base portion activation of the reels, the base portion activation populating at least some of the game symbol locations of the first array with a respective game symbol from a set of game symbols for the base portion of the game; and
(b) the first trigger condition comprises a state of the first array in response to the base portion activation in which a column of game symbol locations in the first array comprises a first bonus stacked symbol group in which each game symbol location in that column of game symbol locations displays a respective first bonus symbol.

11. The gaming machine of claim 10 wherein the instructions are also executable by the processing system to, for a respective activation of the reels which produce the first array, cause the display system to display each respective first bonus symbol in the first bonus stacked symbol group moving one column in a column movement direction.

12. The gaming machine of claim 11 wherein the first bonus feature ends upon awarding any prize for the activation where the first bonus stacked symbol group or a different such first bonus stacked symbol group which has landed in the first array resides in a final column in the column movement direction.

13. The gaming machine of claim 11 wherein the display of the selection from among a number of different bonus feature options comprises a rotation of a selection element where the number of different bonus feature options are defined at different segments of the selection element.

14. The gaming machine of claim 13 wherein the instructions are also executable to:
(a) control the display system so that the second array of game symbol locations includes a column of game symbol locations which comprises a second bonus stacked symbol group in which each game symbol location in that column displays a respective second bonus symbol; and
(b) for a respective activation of the reels which produce the second array, cause the display system to display each respective second bonus symbol in the second bonus stacked symbol group moving one column in a column movement direction.

15. The gaming machine of claim 14 wherein the second bonus feature ends upon awarding any prize for the activation where the second bonus stacked symbol group, or a different such second bonus stacked symbol group which has landed in the second array, resides in a final column of the second array in the column movement direction.

16. The gaming machine of claim 14 wherein the second array of game symbol locations defines twice as many rows as the first array of game symbol locations.

17. A program product comprising one or more non-transitory computer readable data storage devices storing program code for a gaming machine, the program code including:
(a) base game program code executable by a processing system of the gaming machine including at least one processor to cause a display system of the gaming machine to display a base portion of a game in response to a play activation input from a player input system of the gaming machine, the display of the base portion of the game including a base portion result selected from a number of potential base portion results where at least one respective potential base portion result includes a first trigger condition and at least one respective potential base portion result includes a second trigger condition;
(b) first bonus feature program code executable by the processing system to conduct a first bonus feature in response to the base portion result including the first trigger condition, the conduct of the first bonus feature, (i) causing the display system to display a number of reels to produce a first array of game symbol locations having at least two rows and at least two columns, and (ii) causing the display system to display a number of activations of the reels which produce the first array, each activation populating at least some of the game symbol locations of the first array with a respective game symbol from a set of game symbols for the first bonus feature to produce a respective first bonus feature activation result;
(c) bonus feature selection program code executable by the processing system to, where the base portion result includes the second trigger condition, cause the display system to display a selection from among a number of different bonus feature options, the number of different bonus feature options including a reel-type bonus feature option;
(d) second bonus feature program code executable by the processing system to, where the selection identifies the reel-type bonus feature option, conduct a second bonus feature which includes, (i) causing the display system to display a number of reels to produce a second array of game symbol locations larger than the first array of game symbol locations, and (ii) causing the display system to display a number of activations of the reels which produce the second array, each activation populating at least some of the game symbol locations of the second array with a respective game symbol from a set of game symbols for the second bonus feature to produce a respective second bonus feature activation result; and
(e) prize assignment program code executable by the processing system to (i) award any prize defined for the base portion result, and (ii) for each first bonus feature activation result, award any prize defined for any pattern of game symbols present in the first array of game symbol locations for that first bonus feature activation result, and (iii) for each second bonus feature activation result, award any prize defined for any pattern of game symbols present in the second array of game symbol locations for that second bonus feature activation result.

18. The program product of claim 17 wherein the base game program code is executable by the processing system of the gaming machine to:
(a) cause the display system to display a base portion activation of the reels which produce the first array of game symbol locations, the base portion activation populating at least some of the game symbol locations of the first array with a respective game symbol from a set of game symbols for the base portion of the game; and
(b) the first trigger condition comprises a state of the first array in response to the base portion activation in which a column of the game symbol locations in the first array comprises a first bonus stacked symbol group in which each game symbol location in that column of game symbol locations displays a respective first bonus symbol.

19. The program product of claim 18 wherein the first bonus feature program code is executable by the processing system to, for a respective activation of the reels which produce the first array, cause the display system to display each respective first bonus symbol in the first bonus stacked symbol group moving one column in a column movement direction.

20. The program product of claim 19 wherein the second bonus feature program code is executable by the processing system to:
(a) cause the display system to display a state of the second array of game symbol locations in which a column of the game symbol locations in the second array comprises a second bonus stacked symbol group in which each game symbol location in that column displays a respective second bonus symbol; and
(b) for a respective activation of the reels which produce the second array, cause the display system to display each respective second bonus symbol in the second bonus stacked symbol group moving one column in a column movement direction.
